(19) United States
(12) Patent Application Publication
(10) Pub. No.: US 2008/0140683 A1
(43) Pub. Date: Jun. 12, 2008

(54) Virtual community dispute resolution review board

(75) Inventors: Amjad Hanif, Santa Clara, CA (US); Brian Burke, San Jose, CA (US); Jerry T. Chong, San Jose, CA (US); Dan L. Pritchett, San Jose, CA (US); Marc Delingat, Mountain View, CA (US); Robert C. Chesnut, Santa Cruz, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/635,318

(22) Filed: Dec. 7, 2006

(51) Int. Cl. G06F 7/00

(52) U.S. Cl. 707/100

(57) ABSTRACT

Techniques for forming and operating a virtual community dispute resolution board are presented. A virtual community dispute resolution board is custom formed, in response to predefined criteria, to handle disputes that arise between members of a virtual community. Further, the dispute resolution board renders decisions on virtual community disputes in response to operating criteria.

### FIELD

The invention relates generally to virtual communities and more particularly to techniques for forming and instituting dispute resolution boards within virtual communities.

### BACKGROUND

In recent years, the Internet and the World-Wide Web (WWW) have transformed how individuals conduct business and engage in communications with one another. One notable area in which such a transformation has occurred is within virtual communities. Individuals now engage in a variety of on-line communities that can range from personal to business.

As individuals engage in these virtual communities, they acquire reputations within those communities. In fact, some virtual communities support member ratings, which attempt to provide an objective measure for a particular member's reputation within a given community.

One problem with objective measures for gauging a reputation is that specific values supplied for those measures can be manipulated by a disgruntled member who may subjectively, unilaterally, unfairly, and/or perhaps even maliciously attempt to disparage another member of the community. In some cases, the complaining member may be justified in supplying criticism about another member of a community; yet, in other cases, the complaining member may be unjustified.

Because of a variety of concerns associated with attempting to monitor member criticism, many enterprises that operate virtual communities and that supply reputation-based measures have elected to take a hands-off approach or have elected to internally address issues on individual bases. A hands-off approach is attractive because it alleviates an enterprise from administration and support and may, in some cases, absolve the enterprise of legal liability. But, the hands-off approach can quickly divulge into chaos within the community where a few bad seeds dominate or foment rumors and false accusations about upstanding members of the community. Consequently, a complete hands-off approach could result in self destruction of the community. The other approach involves internally addressing conflicts as they arise. The problem with this is that some communities are so large that the overhead associated with doing this internal to a particular enterprise can be extremely problematic. Moreover, because of overhead and resource issues the timeliness of decisions can be too long and may result in upstanding members of the community, which are involved in disputes, leaving the community because of frustrations with the conflict resolution process.

### SUMMARY

In an embodiment, a method to form and operate a virtual community review board is presented. Initially, a virtual community review board is established to resolve disputes within the virtual community. Moreover, the virtual community review board is established in response to one or more first criteria. The virtual community review board also renders decisions on one or more of the disputes occurring within the virtual community in response to one or more second criteria.

Other features will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements.

FIG. 1 is a diagram of a method for forming and operating a virtual community review board, according to an example embodiment.

FIG. 2 is a diagram of method for resolving disputes within a virtual community, according to an example embodiment.

FIG. 3 is a diagram of a virtual community dispute resolution system, according to an example embodiment.

FIG. 4 is a diagram of another virtual community dispute resolution system, according to an example embodiment.

FIG. 5 is a diagram of example network-based commerce system or facility which implements various embodiments associated with the invention.

FIG. 6 is a diagram of example applications implemented within some of the components of the network-based commerce system of FIG. 5.

FIG. 7 is a diagram of machine architecture which implements various aspects of the invention, according to an example embodiment.

### DETAILED DESCRIPTION

Methods and systems for forming virtual community review boards and for resolving disputes within a virtual community are described. In the following description, for purposes of explanation, numerous specific details are set forth in order to provide a thorough understanding of embodiments of the invention. It will be evident, however, to one of ordinary skill in the art that other embodiments of the invention may be practiced without these specific details.

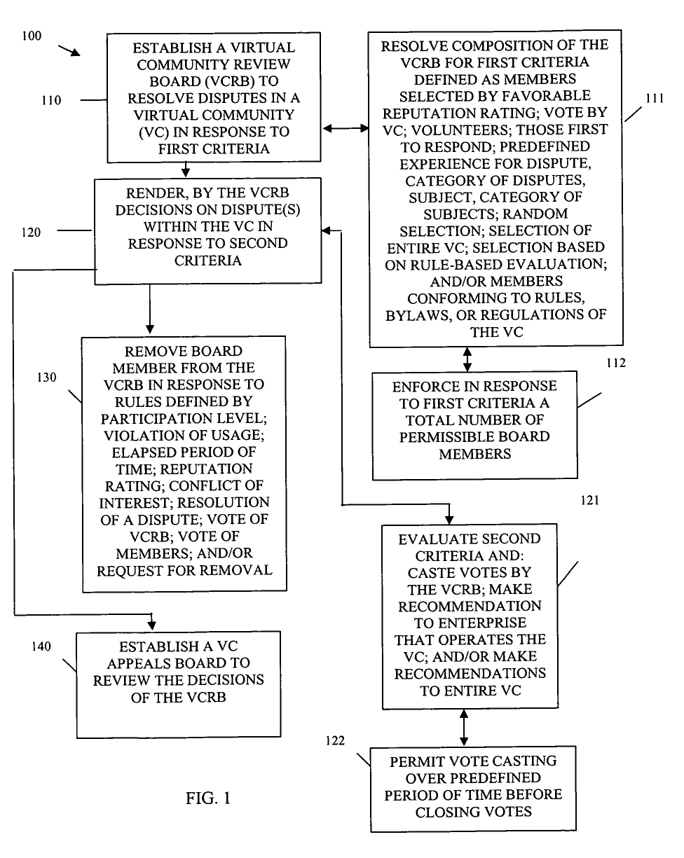

FIG. 1 is a diagram of a method 100 for forming and operating a virtual community review board, according to an example embodiment. The method 100 (hereinafter “dispute review board service”) is implemented in a machine-accessible and/or readable medium and is accessible over a network. The network may be wired, wireless, or a combination of wired and wireless.

Initially, a virtual community is established and operational. For example, eBay® of San Jose, Calif. may be viewed as an example virtual community for buying and selling goods and services. The virtual community includes members and these members act as buyers, sellers, etc. depending upon any given transaction. In some cases, the members may just be browsing or shopping and not actually buying. It is also to be understood that other virtual communities may be used with the teachings presented herein, such that the teachings are not intended to be limited to any particular virtual community exclusively.

At 110, the dispute review board service establishes or facilitates the establishment of a virtual community review board to resolve disputes, which occur within the virtual community. The virtual community review board is established in response to one or more first criteria. Disputes may arise for a variety of reasons, such as: due to undesirable feedback comments or reputation ratings; in response to a belief that one party needs to consummate a transaction; etc. Typically, disputes are resolved by the enterprise that hosts or operates the virtual community. However, in large transactional virtual communities this can create significant administrative expense and cause unnecessary delays. With the teachings presented herein, this administrative burden is relieved, as will be described more completely herein and below.

At 111, the dispute review board service resolves the composition or makeup of the virtual community review board by evaluating the first criteria to select members from the virtual community. The one or more first criteria may be defined such that members of the board are selected: by favorable reputation ratings within the community as determined by some threshold rating value; by vote of the virtual community members; by volunteers requesting to serve on the board; by members that are the first to respond to a request to serve on the board; by selecting members having a predefined experience level in a particular dispute or particular category of disputes; by selecting members having a predefined experience level in a particular subject matter or particular class or category of subject matters; by randomly selecting members from the community as a whole; by selecting the entire or whole virtual community to serve as the board; and/or by selecting members that conform to rules, bylaws, or regulations of the virtual community members for selecting board members. It is also to be understood that composition of the review board may be members selected by rule-based evaluation of data available in the market or a set of members including, but not limited to, their user attributes, reputation/feedback history, transaction history, etc.

As another set of examples, consider that the virtual community review board may be selected as members that have bought or sold a good or service that is the subject of the dispute. In some other cases, the board may be comprised of members that bought or sold similar items as that which is the subject of the dispute. There may also be filtering criteria to avoid conflicts, such that members residing in the same state or locale as a party involved in the dispute may be excluded as being board members.

It is to be understood that the dispute review board service may use a single first criteria or multiple first criterion. It is also noted that the above list of criteria is presented for purposes of illustration and is not intended to limit the teachings presented herein, as any configured and desired first criteria may be used by the dispute review board service to initially establish the virtual community review board.

According to an embodiment, at 112, the dispute review board service may resolve the composition of the virtual community review board by enforcing a predefined total number of permissible board members to serve on the board. For example, the dispute review board service may enforce that an odd number of board members (e.g., 9, 11, 13 board members) may permissibly comprise the board. The total number of members that serve on the board may also be part of the first criteria enforced by the dispute review board service when forming the virtual community review board. Alternatively, in some situations, the virtual community review board may be the entire membership of the virtual community.

At 120, the dispute review board service permits the virtual community review board to render decisions on one or more disputes that occur within the virtual community in response to one or more second criteria. That is, the virtual community review board is formed to render decisions on disputes. The board may be formed for a particular dispute, a particular class of disputes, or all disputes for a given period of time.

According to an embodiment, at 121, the dispute review board service may evaluate the one or more second criteria by: members of the board casting votes, such that a predefined margin (e.g., simple majority (>51%), two-thirds, three-fourths, etc.) is used to make decisions on the disputes; members of the board making recommendations to an enterprise that operates the virtual community where the enterprise renders final decisions in response to the board recommendations; or members of the board making recommendations to the virtual community as a whole where the community members subsequently vote to make final decisions to resolve the disputes. So, the board may make final determinations on how a dispute is to be resolved; or alternatively, the board may make recommendations to other entities where those other entities then make final determinations as to how the dispute is resolved when considering the board recommendations.

In an embodiment, at 122, the dispute review board service may also permit the manner or procedure in which the board casts votes, if such a technique is being used, to be controlled or dictated. Thus, the second criteria may also define procedure for vote casting, such that a vote remains open for a predefined period of time before it closes.

In some situations, at 130, the dispute review board service may also monitor board members' behavior or other circumstances, which may result in removing one or more of the board members. For example, the dispute review board service may remove a board member in response to rules that dictate: that a member maintain a certain predefined participation level on the board; that a member not violate usage rules associated with the virtual community; that a member not exceed serving on the board for some elapsed period of time (e.g., 1 week, 1 month, 1 year, etc.); that a member maintain a certain reputation rating within the community; that a member not have a conflict with a particular dispute (e.g., familiar or business relationship with one of the parties in the dispute, etc.); that a member not serve any longer once a particular dispute or class of disputes is resolved; that a member be removed by vote of the remaining board members or by vote of the entire community; that a member be removed when the member voluntarily requests removal; etc. It is understood that other rules may be defined that result in a particular board member being removed or that result in the entire board being removed.

In some embodiments, at 140, decisions of the virtual community review board may be challenged by parties engaged in a dispute that the board renders the decision for. So, the dispute review board service may permit board decisions to be taken up on appeal to another virtual community appeals board. The appeals board may be formed in manners similar to or using one or more third criteria. The manner in which the appeals board operates and processes to render decisions on appeal may be defined by one or more fourth criteria. In some cases, virtual community appeal's board members (or at least some percentage of members) may be appointed by the enterprise that operates the virtual community.

It is now understood how dispute resolution within a virtual community can be self managed and administered by members of the virtual community with little to no administrative overhead associated with the enterprise that operates or provides the virtual community. This results in more timely decisions and decisions that appear to be more democratic and thus are more likely to be accepted by members of the community.

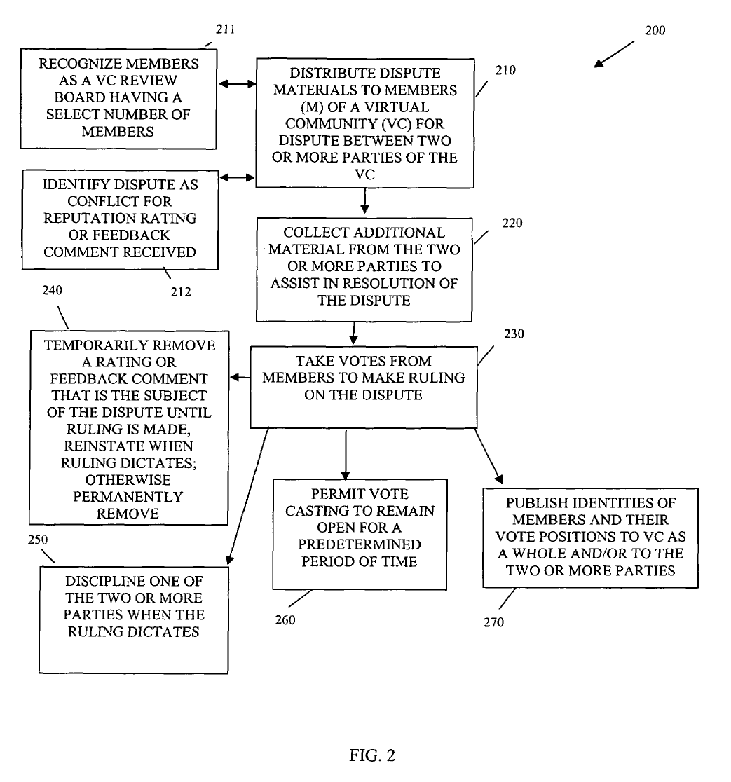

FIG. 2 is a diagram of method 200 for resolving disputes within a virtual community, according to an example embodiment. The method 200 (hereinafter referred to as “dispute resolution service”) is implemented in a machine-accessible and/or readable medium and is accessible over a network. The dispute resolution service presents an enhanced perspective for some aspects of the dispute review board service discussed above with respect to the method 100 and the FIG. 1.

Although method 100 illustrates how a virtual community review board is formed and processes, the dispute resolution service represented by the method 200 focuses more on the decision making and resolution process for handling disputes within the virtual community.

At 210, the dispute resolution service distributes or facilitates the distribution of dispute materials to members of a virtual community for a dispute between two or more parties of a virtual community. The initial dispute materials may identify the parties involved, the subject matter of the dispute, and what is being requested by the complaining party.

According to an embodiment, at 211, the dispute resolution service may recognize the members of the virtual community as a logical entity referred to as a virtual community review board, which has a select number of members. The formation and procedures of the review board were discussed above with reference to the method 100 and the FIG. 1.

In an embodiment, at 212, the dispute resolution service may identify the dispute as a conflict between two parties over a reputation rating or feedback comment received by one of the parties from the remaining party. It is to be understood that the dispute can relate to other matters as well, such as non payment or non delivery of a good or service, etc.

At 220, the dispute resolution service collects additional material from the two or more parties to assist the members in resolving the dispute or in rendering a decision on the dispute. For example, the additional material may be received in response to specific questions that the members have for the parties or may be unsolicited material received from the parties, such as emails, instant messages, audio, video, documents, etc.

At 230, the dispute resolution service takes votes from the members to make a ruling on the dispute. Depending upon the subject matter of the dispute, the percentage of votes used to make a ruling may vary. Thus, if the dispute is just associated with removing a feedback comment, then the percentage of votes may be a simple majority. Conversely, if the subject matter of the dispute is related to removing a member from the virtual community entirely, then the percentage of votes may be a three-fourths majority.

According to an embodiment, at 230, the dispute resolution service may temporarily remove a reputation rating or unfavorable feedback comment from being viewed within the virtual community, when the rating or comment is the subject matter of the dispute and while the dispute is pending. If the members make a ruling in favor of permitting the rating or comment to post, then when the ruling is made the rating or comment posts to the virtual community. However, if the members make a ruling in favor of denying the rating or comment from posting to the community, then the rating or comment is permanently removed.

In some cases, at 240, the dispute resolution service may permit the members to discipline one of the two or more parties when the ruling dictates. In other words, the ruling may do more than just make a decision to grant what one of the parties is requesting or deny what is being requested; the ruling may determine that some actions or even the bringing of the dispute to the members in the first instance was egregious. In such situations a party may be disciplined by having some features of the virtual community suspended for some defined period of time or in a worse case by being expelled entirely from the virtual community. Of course varying degrees of discipline can occur and the above example was presented for purposes of illustration only.

In an embodiment, at 250, the dispute resolution service may permit the vote casting of the members to remain open for a predetermined period of time. So, votes may be casts for a week, a month, a day, any configurable period of time, etc.

In still another embodiment, at 260, the dispute resolution service may publish the identities or virtual community member identifiers of the voting members along with their corresponding vote positions. This information may be published to the parties involved in the dispute and/or to the entire membership of the virtual community. In other situations, the raw vote totals may be published but the identities of the voters and their vote positions may remain anonymous. In still other cases, the identities of the voters may be published and raw vote totals may be published but a position of a particular voter on a given dispute is not published or known.

It is also understood that the voting or procedures used to render decisions on a pending dispute may be implemented in a variety of manners. For example, in some cases, the board members may engage in a real-time conference chat using Voice Over Internet Protocol (VOIP) or other voice technologies that is integrated as a plug in module within the virtual community. Video conferencing may be used in combination with the VOIP technique as well. In other cases, online chats may be used, instant messaging, electronic mail, electronic form voting, etc.

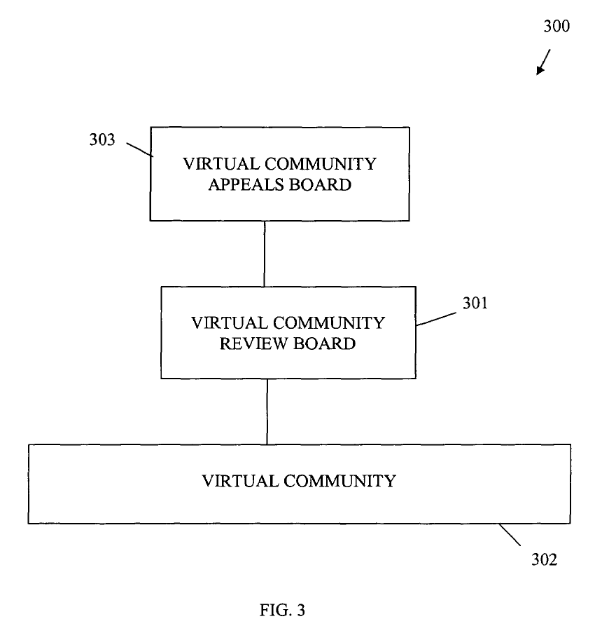

FIG. 3 is a diagram of a virtual community dispute resolution system 300, according to an example embodiment. The virtual community dispute resolution system 300 is implemented in and processes as instructions within a machine-accessible and/or readable medium and is also accessible over a network. The network may be wired, wireless, or a combination of wired and wireless. The virtual community dispute resolution system 300 implements, among other things, the processing depicted by the dispute review board service and the dispute resolution service represented as the methods 100 and 200 and described above with reference to FIGS. 1 and 2, respectively.

In an embodiment, the virtual community dispute resolution system 300 may be implemented within a network-based service, such as but not limited to, a network-based transaction service such as eBay® of San Jose, Calif.

The virtual community dispute resolution system 300 includes a virtual community review board 301 and a virtual community 302. The virtual community dispute resolution system 300 may also include a virtual community appeals board 303. Each of these components and their interaction with one another will now be discussed in turn.

The virtual community review board 301 is logically represented and operates as a logical entity within a machine-accessible medium. Similarly, the virtual community 302 is logically represented and operates as another logical entity within a machine-accessible medium. In some cases, the virtual community review board 301 is carved out of and is a logical subset of the virtual community 302 and its membership. Thus, some members of the virtual community 302 are also members of the virtual community review board 301.

The virtual community review board 301 may be formed programmatically and in an automated fashion according to criterion, as was described in detail above with reference to the method 100 of the FIG. 1. The manner or procedures in which the virtual community review board 301 operates to handle and render decisions on disputes that occur with members of the virtual community 302 were discussed in detail above with reference to the methods 100 and 200 of the FIGS. 1 and 2, respectively.

The virtual community review board 301 is formed and operates to review disputes between members of the virtual community 302 and to render decisions on those disputes. The virtual community review board 301 may be formed according to one or more predefined criteria. Additionally, the virtual community review board 301 may serve or exists for a predetermined period of time, for the life span of a particular dispute, or for a life span of a particular type or class of disputes.

The virtual community review board 301 casts votes to render decisions on disputes. In some cases, the decisions of the virtual community review board 301 are recommendations for further actions to an enterprise that operates the virtual community 302 or the decisions are recommendations to the virtual community 302 as a whole.

The virtual community dispute resolution system 300 may also include a virtual community appeals board 303. The virtual community review board 301 renders decisions on disputes and those decisions may in some cases be appealed to the virtual community appeals board 303. The subject matter of the types of decisions handled by the appeals board 303 may be defined by criteria or rules associated with the virtual community or even the enterprise that operates the virtual community 302.

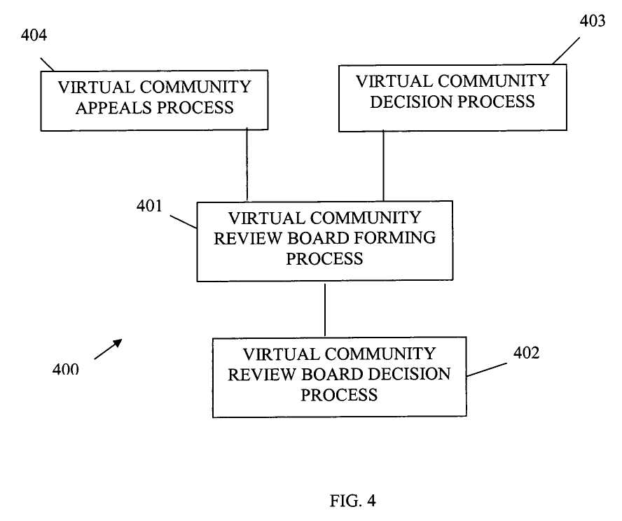

FIG. 4 is a diagram of another virtual community dispute resolution system 400, according to an example embodiment. The virtual community dispute resolution system 400 is implemented in a machine-accessible and/or readable medium and is accessible over a network. The virtual community dispute resolution system 400 presents another view of the virtual community dispute resolution system 300 described with reference to the FIG. 3. Thus, the virtual community dispute resolution system 400 also implements, among other things, the processing depicted by the dispute review board service and the dispute resolution service represented by the methods 100 and 200 and described above with reference to FIGS. 1 and 2, respectively.

The virtual community dispute resolution system 400 includes a virtual community review board forming process 401 and a virtual community review board decision process 402. In some cases, the virtual community dispute resolution system 400 may also include a virtual community appeals process 403 and/or a virtual community discipline process 404. Each of these components and their interaction with one another will now be discussed in turn.

The virtual community review board forming process 401 is implemented as software and may be considered a means to form a virtual community review board. The virtual community review board forming process 401 uses rules or criteria to initial form and select a review board. The review board may serve and operate according to other rules or criteria. Some example processing for forming a review board for a virtual community were discussed and presented above with respect to the method 100 of the FIG. 1 and the system 300 of the FIG. 3.

The virtual community review board decision process 402 is implemented as software and may be considered a means to render decisions on disputes between members of a virtual community. The decision process 402 may also be governed by rules or criteria. Some example processing for rendering decisions on disputes raised by members of a virtual community was presented above with respect to the methods 100 and 200 of the FIGS. 1 and 2 and the system 300 of the FIG. 3.

In some cases, the virtual community dispute resolution system 400 may also include a virtual community appeals process 403. The appeals process 403 permits decisions or selected decisions rendered by the decision process 402 to be reviewed a second time. Some example processing associated with an appeals board was presented above with respect to the method 200 of the FIG. 1 and the system 300 of the FIG. 3.

According to an embodiment, the virtual community dispute resolution system 400 may also include a virtual community discipline process 404. The decision process 402 may include additional rules or criteria that permit members associated with a decision on a dispute to also be disciplined. Some examples associated with disciplining members involved in a dispute were presented above with respect to the method 200 of the FIG. 2.

In some cases, the processing with respect to the methods 100 and 200 of the FIGS. 1 and 2 may be implemented as instructions that when accessed by a machine perform the processing described herein and above. The instructions may be interfaced to the machine via a network download, via interfacing removable media to a machine, via prefabrication within memory or storage of a machine, etc.

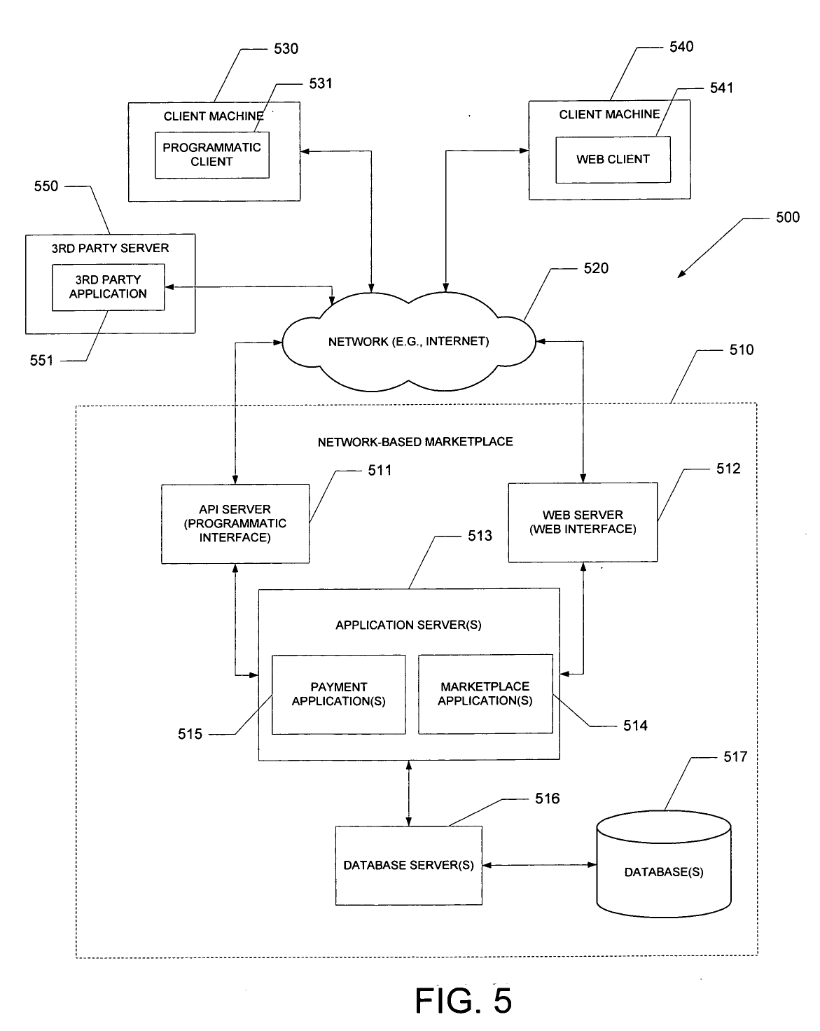

FIGS. 5-7 are now presented as example implementations of the virtual community dispute resolution review board and techniques for operating the virtual community resolution review broad, as was described herein and above. It is understood that these example architectures and arrangements are presented for purposes of illustration only and are not intended to limit other implementations of the teachings presented.

FIG. 5 is a diagram of example network-based commerce system or facility 500 which implements various embodiments associated with the invention. A commerce system 500, in the example form of a network-based marketplace, provides server-side functionality, via a network 520 (e.g., the Internet) to one or more clients.

FIG. 5 illustrates, for example, a web client 541 (e.g., a browser, such as the Internet Explorer browser developed by Microsoft Corporation of Redmond, Wash.), and a programmatic client 531 executing on respective client machines 540 and 530.

An API server 511 and a web server 512 are coupled to, and provide programmatic and web interfaces respectively to, one or more application servers 513. The application servers 513 host one or more marketplace applications 514 and payment applications 515. The application servers 513 are, in turn, shown to be coupled to one or more databases servers 516 that facilitate access to one or more databases 517.

The marketplace applications 514 provide a number of marketplace functions and services to users that access the commerce system 510. The payment applications 515 likewise provide a number of payment services and functions to users. The payment applications 515 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 514. While the marketplace and payment applications 514 and 515 are shown in FIG. 5 to both form part of the commerce system 510, it will be appreciated that, in alternative embodiments, the payment applications 515 may form part of a payment service that is separate and distinct from the commerce system 510.

Further, while the system 500 shown in FIG. 5 employs a client-server architecture, the present invention is of course not limited to such an architecture, and could equally well find application in a distributed, or peer-to-peer, architecture system for example. The various marketplace and payment applications 514 and 515 could also be implemented as standalone software programs, which do not necessarily have networking capabilities.

The web client 541 accesses the various marketplace and payment applications 514 and 515 via the web interface supported by the web server 512. Similarly, the programmatic client 531 accesses the various services and functions provided by the marketplace and payment applications 514 and 515 via the programmatic interface provided by the API server 511. The programmatic client 531 may, for example, be a seller application (e.g., the TurboLister application developed by eBay Inc., of San Jose, Calif.) to enable sellers to author and manage listings on the commerce system 510 in an off-line manner, and to perform batch-mode communications between the programmatic client 531 and the network-based commerce system 510.

FIG. 5 also illustrates a third party application 551, executing on a third party server machine 550, as having programmatic access to the network-based commerce system 510 via the programmatic interface provided by the API server 511. For example, the third party application 551 may, utilizing information retrieved from the network-based commerce system 510, support one or more features or functions on a website hosted by the third party. The third party website may, for example, provide one or more promotional, marketplace or payment functions that are supported by the relevant applications of the network-based commerce system 510.

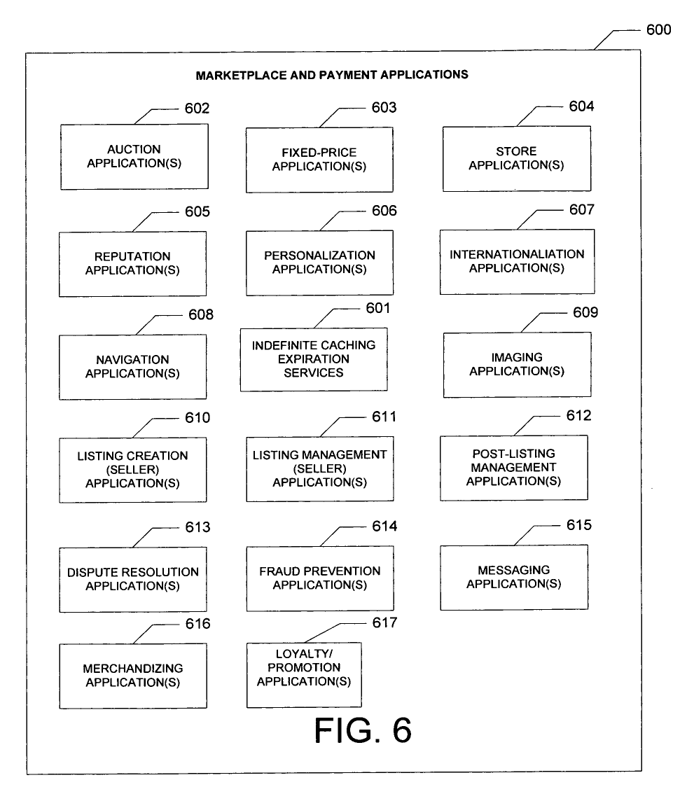

FIG. 6 is a diagram of example applications 600 implemented within some of the marketplace applications 514 of the network-based commerce system 510 of FIG. 5. The applications 600 may be hosted on dedicated or shared server machines (not shown) that are communicatively coupled to enable communications between server machines. The architecture of one such example server machine is provided below. The applications themselves are communicatively coupled (e.g., via appropriate interfaces) to each other and to various data sources, so as to allow information to be passed between the applications or so as to allow the applications to share and access common data.

The virtual community review board applications 601 provide the novel virtual community dispute resolution services described herein. These applications 601 are coupled or interfaced with a variety of other applications in a commerce system 510.

The commerce system 510 may provide a number of listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 600 are shown to include one or more auction applications 602 which support auction-format listing and price setting mechanisms (e.g., English, Dutch, Vickrey, Chinese, Double, Reverse auctions etc.). The various auction applications 602 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 603 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 604 allow sellers to group their listings within a “virtual” store, which may be branded and otherwise personalized by and for the sellers. Such a virtual store may also offer promotions, incentives and features that are specific and personalized to a relevant seller.

Reputation applications 605 allow parties that transact utilizing the network-based commerce system 510 to establish, build, and maintain reputations, which may be made available and published to potential trading partners. Consider that where, for example, the network-based commerce system 510 supports person-to-person trading, users may have no history or other reference information whereby the trustworthiness and credibility of potential trading partners may be assessed. The reputation applications 605 allow a user, for example through feedback provided by other transaction partners, to establish a reputation within the network-based commerce system 510 over time. Other potential trading partners may then reference such a reputation for the purposes of assessing credibility and trustworthiness.

Personalization applications 606 allow users of the commerce system 510 to personalize various aspects of their interactions with the commerce system 510. For example a user may, utilizing an appropriate personalization application 606, create a personalized reference page at which information regarding transactions to which the user is (or has been) a party may be viewed. Further, a personalization application 606 may enable a user to personalize listings and other aspects of their interactions with the commerce system 510 and other parties.

The network-based commerce system 510 may support a number of marketplaces that are customized, for example, for specific geographic regions. A version of the commerce system 510 may be customized for the United Kingdom, whereas another version of the commerce system 510 may be customized for the United States. Each of these versions may operate as an independent marketplace, or may be customized (or internationalized) presentations of a common underlying marketplace. These are represented as the internationalization applications 607 in FIG. 6.

Navigation of the network-based commerce system 510 may be facilitated by one or more navigation applications 608. For example, a search application enables key word searches of listings published via the commerce system 510. A browse application allows users to browse various category, catalogue, or inventory data structures according to which listings may be classified within the commerce system 510. Various other navigation applications may be provided to supplement the search and browsing applications.

In order to make listings, available via the network-based commerce system 510, as visually informing and attractive as possible, the marketplace applications 600 may include one or more imaging applications 609 utilizing which users may upload images for inclusion within listings. An imaging application 609 also operates to incorporate images within viewed listings. The imaging applications 609 may also support one or more promotional features, such as image galleries that are presented to potential buyers. For example, sellers may pay an additional fee to have an image included within a gallery of images for promoted items.

Listing creation applications 610 allow sellers conveniently to author listings pertaining to goods or services that they wish to transact via the commerce system 510 and listing management applications 611 allow sellers to manage such listings. Specifically, where a particular seller has authored and/or published a large number of listings, the management of such listings may present a challenge. The listing management applications 611 provide a number of features (e.g., auto-re-listing, inventory level monitors, etc.) to assist the seller in managing such listings. One or more post-listing management applications 612 also assist sellers with a number of activities that typically occurs post-listing. For example, upon completion of an auction facilitated by one or more auction applications 602, a seller may wish to leave feedback regarding a particular buyer. To this end, a post-listing management application 612 may provide an interface to one or more reputation applications 605, so as to allow the seller conveniently to provide feedback regarding multiple buyers to the reputation applications 605.

Dispute resolution applications 613 provide mechanisms whereby disputes arising between transacting parties may be resolved. For example, the dispute resolution applications 613 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 614 implement fraud detection and prevention mechanisms to reduce the occurrence of fraud within the commerce system 510.

Messaging applications 615 are responsible for the generation and delivery of messages to users of the network-based commerce system 510, such messages for example advising users regarding the status of listings at the commerce system 510 (e.g., providing “outbid” notices to bidders during an auction process or to provide promotional and merchandising information to users).

Merchandising applications 616 support various merchandising functions that are made available to sellers to enable sellers to increase sales via the commerce system 510. The merchandising applications 616 also operate the various merchandising features that may be invoked by sellers, and may monitor and track the success of merchandising strategies employed by sellers.

The network-based commerce system 510 itself, or one or more parties that transact via the commerce system 510, may operate loyalty programs that are supported by one or more loyalty/promotions applications 617. For example, a buyer may earn loyalty or promotions points for each transaction established and/or concluded with a particular seller, and may be offered a reward for which accumulated loyalty points can be redeemed.

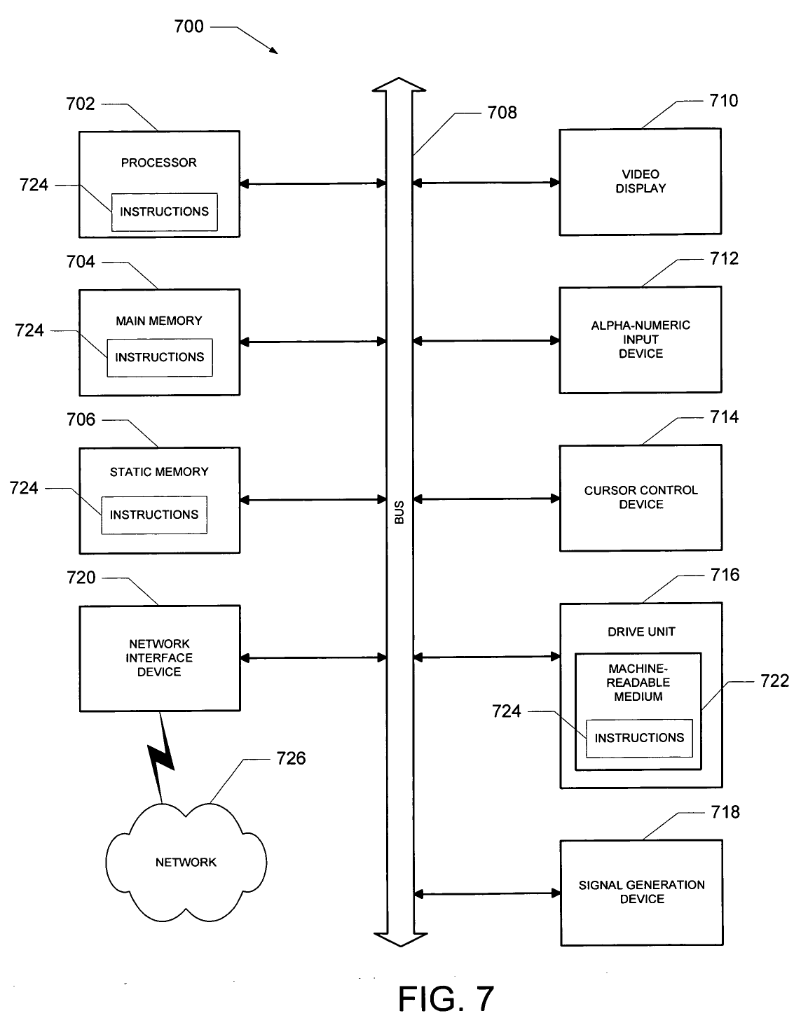

FIG. 7 is a diagram of machine architecture 700 which implements various aspects of the invention, according to an example embodiment. The machine includes a set of instructions, which when executed on the machine cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer architecture 700 includes a processor 702 (e.g., a central processing unit (CPU) a graphics processing unit (GPU) or both), a main memory 704 and a static memory 706, which communicate with each other via a bus 708. The architecture 700 may further include a video display unit 710 (e.g., a liquid crystal display (LCD) or a cathode ray tube (CRT)). The architecture 700 also includes an alphanumeric input device 712 (e.g., a keyboard), a cursor control device 814 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the architecture 700, the main memory 704 and the processor 702 also constituting machine-readable media.

The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to provide novel virtual community dispute resolution services have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The above description is illustrative, and not restrictive. Many other embodiments will be apparent to those of ordinary skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A method, including:
establishing a virtual community review board to resolve disputes within the virtual community, wherein the virtual community review board is established in response to one or more first criteria;
rendering, by the virtual community review board, decisions on one or more of the disputes occurring within the virtual community in response to one or more second criteria.

2. The method of claim 1, wherein establishing further includes resolving the composition of the virtual community review board in response to the one or more first criteria, which are defined as one or more of the following:
a selection of existing virtual community members having a favorable reputation rating determined by a threshold rating value;
a selection of existing virtual community members voted to serve on the virtual community review board by members of the virtual community;
a selection of existing virtual community members that volunteer to serve on the virtual community review board;
a selection of existing virtual community members that are first to respond to a request to serve on the virtual community review board;
a selection of existing virtual community members having a predefined experience level in a particular dispute or in a particular category of disputes;
a selection of existing virtual community members having a predefined experience level in a particular subject matter or in a particular class of subject matters that arise within the virtual community;
a selection of randomly determined existing virtual community members;
a selection of existing virtual community members representing the entire virtual community; and
a selection of existing virtual community members that conforms to rules, bylaws, or regulations established by the members of the virtual community.

3. The method of claim 2, wherein resolving further includes, enforcing in response to a particular one of the first criteria a total number of permissible board members that serve on the virtual community review board.

4. The method of claim 1 further including, removing a particular board member from the virtual community review board in response to defined rules, wherein the defined rules include one or more of the following:
a lack of a predefined participation level;
a violation of usage rules associated with the virtual community;
a defined elapsed period of time for which serving on the virtual community review board has expired;
a reputation rating that falls below a threshold;
a detection of a predefined conflict of interest;
a resolution to a particular dispute for which the virtual community review board was initially established;
a vote by other board members of the virtual community review board that results in a predefined margin of votes requesting removal;
a vote by members of the virtual community that results in a predefined margin of votes requesting removal; and
a request by the particular board member to be voluntarily removed from the virtual community review board.

5. The method of claim 1, wherein rendering further includes evaluating the one or more second criteria to render the decisions by performing one or more of the following:
casting votes by the virtual community review board, wherein a predefined margin of the votes results in the decisions for resolving the disputes;
making recommendations by the virtual community review board to an enterprise associated with operating the virtual community, wherein the enterprise makes final determinations for resolving the disputes; and
making recommendations by the virtual community review board to the entire virtual community for members of the virtual community to vote in order to make final determinations for resolving the disputes.

6. The method of claim 5, wherein casting further includes permitting the votes to be made for a predefined period of time before closing the votes.

7. The method of claim 1 further including, establishing a virtual community appeals board to review the decisions on the disputes made by the virtual community review board.

8. A method, including:
distributing dispute material to members of a virtual community for a dispute between two or more parties of the virtual community;
collecting additional material from the two or more parties to assist in resolution of the dispute; and
taking votes from the members to make a ruling on the dispute.

9. The method of claim 8, wherein distributing further includes recognizing the members as one of a virtual community review board having a select number of pre-selected members or the entire virtual community.

10. The method of claim 8, wherein distributing further includes identifying the dispute as a conflict associated with a reputation rating or a feedback comment received by one of the two or more parties.

11. The method of claim 8 further including, temporarily removing a reputation rating or feedback comment that is a subject of the dispute until the ruling is made and when the ruling is made reinstating the reputation rating or the feedback comment when the ruling dictates otherwise permanently preventing the reputation rating or the feedback comment from posting to the virtual community.

12. The method of claim 8 further including, disciplining one of the two or more parties in response the ruling when the ruling dictates.

13. The method of claim 8, wherein taking further includes permitting casting of the votes to remain open for a predetermined period of time.

14. The method of claim 8 further including, publishing identities of the members and their vote positions to the virtual community as a whole or to the two or more parties when the ruling is made.

15. A system, including:
a virtual community review board represented in and operating in a machine-accessible medium; and
a virtual community represented in and operating in the machine-accessible medium, wherein the virtual community review board is to review disputes between members of the virtual community and is to render decisions on those disputes.

16. The system of claim 15, wherein the disputes are to be associated with unfavorable reputation ratings or unfavorable feedback comments between the members.

17. The system of claim 15, wherein the virtual community review board is to serve for one or more of the following: a predetermined period of time, a particular dispute, and a particular type of dispute.

18. The system of claim 15, wherein the virtual community review board is to be formed in response to one or more predefined criteria.

19. The system of claim 15, wherein the virtual community review board is to cast votes to render the decisions.

20. The system of claim 15, wherein the virtual community review board is to render the decisions as recommendations for actions to one of an enterprise that operates the virtual community or the virtual community.

21. The system of claim 15 further including, a virtual community appeals board represented in and operating in the machine-accessible medium to review the decisions of the virtual community review board.

22. A system, including:
a means for forming a virtual community review board that is to operate and be represented within a machine-accessible medium; and
a means for the virtual community review board to render decisions on disputes between members of a virtual community that is also to operate and be represented within the machine-accessible medium.

23. The system of claim 22 further including, a means to resolve appeals associated with the rendered decisions.

24. The system of claim 22 further including, a means to discipline members in response to the rendered decisions.

25. A machine readable medium embodying instructions that, when executed by a machine, cause the machine to perform any one of the claims 1 or 8.
